(19) United States
(12) Patent Application Publication
(10) Pub. No.: US 2017/0219219 A1
(43) Pub. Date: Aug. 3, 2017

(54) DEMAND BASED HVAC (HEATING, VENTILATION, AIR CONDITIONING) CONTROL

(71) Applicants: Keith A. Miller, Boylston, MA (US); Marjorie S. Miller, Holden, MA (US)

(72) Inventors: Keith A. Miller, Boylston, MA (US); Marjorie S. Miller, Holden, MA (US)

(21) Appl. No.: 15/012,047

(22) Filed: Feb. 1, 2016

(51) Int. Cl. F24D 19/10; G05B 19/042; F24D 3/02

(52) U.S. Cl. CPC F24D 19/1012; F24D 3/02; F24D 19/1048; G05B 19/042; F24D 2200/04; F24D 2220/02; F24D 2220/042; F24D 2220/044; G05B 2219/2614

(57) ABSTRACT

A demand based control for a hydronic heating system varies the heat response based on an actual demand of the conditioned space, rather than an estimated thermal loss. Differences between supply and return of a heat transfer medium, such as forced hot water, are measured for the conditioned space, as well as the flow rate of the forced water to determine an actual thermal transfer to the conditioned space. A required heat generation is computed based on the measured transfer and resultant temperature change of the conditioned space, and heat generation parameters such as boiler firing rate and circulator pump speed varied to control the heat transfer to the conditioned space and avoid overshoot or excessive heat generation beyond that needed for the measured demand.

### BACKGROUND

Conventional Heating, Ventilation and Air Conditioning (HVAC) systems maintain temperatures in interior, or so-called “conditioned spaces.” Conditioned spaces are maintained at a temperature deemed comfortable for inhabitation, typically around 72 degrees Fahrenheit, regardless of the outside ambient temperature. Heating and cooling systems moderate the temperature in the conditioned space as needed in relation to the outside ambient temperature. Since HVAC systems operate on electrical, gas, oil or other fossil fuel energy source, efficiency is desirable to mitigate energy consumption and the expense of running such systems.

Conventional boilers in HVAC systems burn fuel (such as gas or oil) to heat water that is circulated to provide heat to a space. Although many improvements have been made to increase the efficiency of boilers, additional modifications in design and control can optimize the unit's efficiency for any installation setup. In present home installations, many sites have boilers which are oversized for the heating distribution system driven by the boiler system. Heating systems operate a system pump and boiler control independently based on a heating supply water temperature set point.

Many times boilers are installed on hydronic distribution systems that are mismatched. One zone may have a heat distribution device which is optimally sized to meet the required heating demand for a design day. Other systems may have heat distribution devices which are either oversized or undersized. These systems require contractors and homeowners to adjust their system set points for their heating/cooling systems to match system requirements on design days to allow for comfort during that period of time. If only one zone of a system requires an extreme set point to satisfy demand, the other zones of the system have their energy efficiency compromised to allow for the one oversized/undersized zone to operate efficiently regardless of the needs of the remaining zones. The typical installation setup is designed around a worst case scenario to meet the worst performing zone demand requirements instead of looking holistically at individual zone requirements and adjusting system operation setpoints to meet load requirements as required by current system operation.

### SUMMARY

Conventional boilers burn fuel (such as oil or gas) to heat circulating water, which then provides radiant and/or convection energy to a space, typically in the form of heat or hot water. Although many improvements have been made to increase the efficiency of boilers through physical changes, there are still many opportunities to improve the controls. Currently, many residential and commercial hydronic systems are oversized because pumps are designed to meet the maximum output of the boiler. In many cases, the pump operates at the maximum speed, regardless of demand. This excess flow results in higher return water temperatures which lowers the boiler's efficiency because the boiler flue gases do not condense. It also increases the cost of electricity due to pumping fluid in excess of required capacity requirements. Additionally, the firing rate of some boilers is based on a fixed operating set point (based on outdoor ambient temperature) regardless of actual system load. This causes the boiler to cycle on/off more frequently as the boiler capacity and demand aren't properly balanced. It is evident that existing boiler operations lack the intelligence of controlling boiler firing rate and pump speed(s) based on actual demand of the heating distribution system loops.

Configurations herein are based, in part, on the observation that HVAC (Heating, Ventilation and Air Conditioning) systems are often sized based on generalized formulas for heat loss and thermal transfer to the outside, using estimated or generalized values for building materials and area. The heat load is then computed using the range of seasonal ambient temperature of the building location. This tends to result in a worst-case system sizing, to ensure sufficient capacity for environmental extremes. Further, the conventional control systems operate with a simplified thermostatically controlled on/off setting, which directs the heating source between an on state, which directs maximum firing rate and heat generation to the conditioned space, and off, terminating heat flow. Unfortunately, conventional approaches suffer from the shortcoming that the “worst case” sizing coupled with “on/off” and burner firing rate that modulate up to 100% regardless of system demand, these controls can result in excessive heat generation during moderate demand, as the maximum heat generation is invoked to address only a moderate load. This can often result in overshoot of a target temperature, as system inertia operates to inject additional heat beyond the point of a thermostatic setpoint.

Accordingly, configurations herein substantially overcome the shortcomings of conventional worst-case sizing and thermostatic control by providing a demand based control that varies the heat response based on an actual demand of the conditioned space, rather than an estimated thermal load. Differences between supply and return of a heat transfer medium, such as forced hot water, are measured for the conditioned space, as well as the flow rate of the forced water to determine an actual thermal transfer to the conditioned space, typically as a BTU (British Thermal Unit) measurement of load. A required heat generation is computed based on the measured transfer and resultant temperature change of the conditioned space, and heat generation parameters such as boiler firing rate and circulator pump speed varied to control the heat transfer to the conditioned space and avoid overshoot or excessive heat generation beyond that needed for the measured demand.

Configurations herein may be implemented in a programmable controller which utilizes system data to provide optimized control of a residential or commercial boiler. This includes controlling primary and secondary loop pump(s), boiler firing rate, or other variables based on actual zone load characteristics to provide efficient operation. The system inputs, or baseline parameters, are field adjustable during the controller setup. Note that this controller can be incorporated in the boiler, pumps, thermostat, or even be a standalone unit via appropriate interfaces, wiring, etc. The controller defines a system used to receive on/off signals or data, current system/environmental information (OAT, or outside air temperature, zone temperature, pump flow, supply/return water temperature, boiler firing temp etc.), and control output (pump speed, boiler firing temp, etc.) to meet set points.

In further detail, the method for controlling a heating apparatus as disclosed herein includes delivering a hydronic heating fluid such as forced hot water to a conditioned space via a heating circuit for satisfying a heating demand, in which the heating circuit has a supply and return from the conditioned space. Sensors measure a heat transfer resulting from a flow of the heating fluid from the source to the return of the conditioned space, and a controller computes a heating demand of the conditioned space based on the measured heat transfer from the temperature difference and pump speed or fluid volume of the fluid. The controller measures the heat transfer based on a temperature differential between the supply and the return, in which the temperature differential is indicative of the heat transferred from the heating fluid to the conditioned space. The controller regulates the heat delivered to the conditioned space in response to the computed heating demand by varying the pump speed, supply water temperature required, and/or boiler firing rate.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a conditioned space suitable for use with configurations herein;

FIG. 2 is a block diagram of a hydronic system in the conditioned space of FIG. 1;

FIG. 3 is a schematic diagram of control in the hydronic system of FIG. 2;

FIG. 4 is a flowchart of hydronic control of the system in FIG. 3 according to configurations herein;

FIG. 5 is a heat loss graph used for computing the theoretical demand of FIG. 4; and

FIG. 6 is a boiler specification used for implementing the computed demand of FIG. 4.

### DETAILED DESCRIPTION

Configurations below depict an example implementation of a conditioned space as disclosed and claimed herein. The example conditioned space employs a hydronic (forced water) heating system for illustrative purposes, however other HVAC configurations employing thermal manipulation of a fluidic transfer medium may be employed, such as cooling a conditioned space or using steam or forced air as the fluidic transfer medium. References to heating the conditioned space towards a target temperature or setpoint should be taken to address similar operations for cooling (reducing) the temperature towards a setpoint. Thermal manipulations and measurement of the fluidic transfer medium (water, in the disclosed approach) are also applicable to other mediums.

A hydronic system control as disclosed herein dynamically calculates simultaneously occurring loads in a system to provide control of heating system component based on this functionality. The system considers fluid side of the secondary system pumping capacity allowing intelligent primary pumping control based on zone demand which allows primary pump to only operate at the minimum required gpm (gallons per minute) output to satisfy system requirements which will enable lower boiler supply/return water temperatures and increased boiler/pump operating efficiency. Such control will enable load calculations to index firing rate for burner capacity in addition to allowing for controlling the GPM to the primary and secondary pump(s) of the boiler system to only operate at the required gpm to satisfy BTU load requirements.

Conventional approaches to hydronic and HVAC control include the following. U.S. Pat. No. 5,540,555, to Corso, shows a control system which uses periodically sampled remote sensors to control a water system of the type that includes at least one primary pump, at least one heat exchanging device, and at least one variable speed secondary pump.

U.S. Pat. No. 7,069,976, to Lindgren, shows a process and device for controlling the temperature of an outbound secondary flow in a secondary circuit from a heat exchanger by a primary flow in a primary circuit, via a member that regulates the primary flow, influenced by a control unit.

U.S. Pat. No. 5,806,331, to Brown, shows a water-based hot water heat pump including a coupling means for selectively coupling a heat exchange loop with a liquid heat source loop and for diverting a portion of said liquid heat source through said heat exchange loop, and a second means for circulating said liquid heat source through said liquid heat source loop, such that the heat exchange loop is independent of a first circulating means.

U.S. Patent Publication No. 2014/0277764, to Burt, discloses an automatic control valve and actuator assembly that includes a valve configured to control a flow of fluid into a heat exchanger load or HVAC coil, in which the valve actuator includes an integral fluid flow and energy consumption calculation and retention module configured to calculate heat energy for energy consumption tracking. Conventional approaches to hydronic system control do not teach a multi-loop supply and pump speed based flow control for achieving a computed BTU heating demand, as now disclosed in further detail.

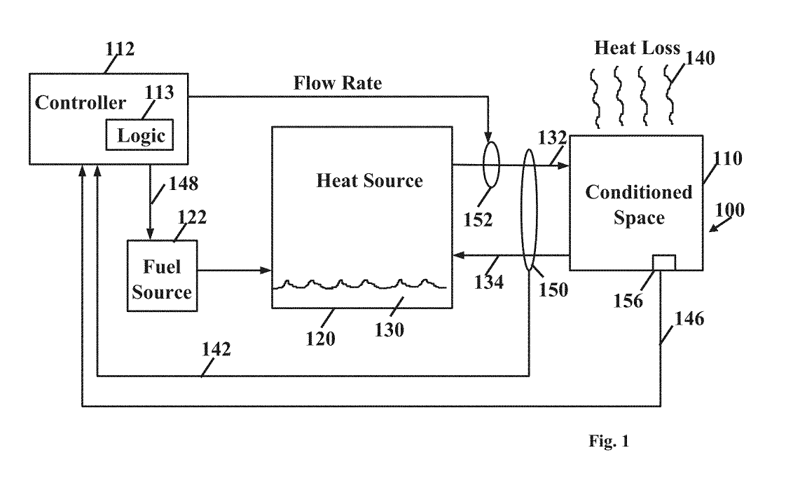

FIG. 1 is a context diagram of a conditioned space suitable for use with configurations herein. Referring to FIG. 1, a heat source 130 delivers a hydronic heating medium or fluid 130 to a conditioned space 110 for satisfying a heating demand, and measures the heat transfer to the conditioned space by the heating fluid 130, such as by measured BTUs. A controller 112 computes an actual heating demand of the conditioned space 110 based on the measured heat transfer, and regulates the heat delivered to the conditioned space 110 in response to the computed heating demand. In the HVAC environment 100, a conditioned space 110 is heated from a heat source 120 by circulation of a fluidic heating medium 130 such as forced hot water. The heating medium 130 flows to the conditioned space 110 through a supply line 132, gives off heat to the conditioned space 110, and returns via a return line 134 to again be heated for circulation through the conditioned space 110. Heat loss 140 from the conditioned space is accommodated by the heat given off by the heating medium 130, and is affected by such factors as outside ambient temperature and insulation around the conditioned space. Generally, a conditioned space 110 experiences a net heat loss 140 which may be affected by thermal efficiency, construction, etc., but nonetheless exhibits a continuous cycle of thermal input to offset the heat loss 140 and maintain the conditioned space at a comfortable temperature. Therefore, the hot water is circulated at regular intervals to accommodate the heat loss.

Heat from the hot water 130 transfers to the conditioned space 110 through radiators or other convection based exchange for passing air in the conditioned space 110 across a surface heated by the hot water. The term “conditioned space” as applied herein to HVAC systems refers generally to a heating demand including at least one of an interior region and a potable hot water supply, as these domestic needs are often driven from a common heat plant (boiler or furnace). Conversely, the hot water cools from the exchanged heat. A temperature differential 150 is exhibited between the supply 132 and return 134 lines based on the heat transferred to the conditioned space. Concurrent measurement of the amount of hot water circulated through the conditioned space 110 provides an accurate measurement of the heat transferred, or consumed, by the conditioned space from the volume and temperature drop of the hot water.

In configurations herein, a circulator pump 152 has a flow rate responsive to a controller 112 for controlling a pumped volume based on pump speed. The controller 112 receives a heat differential signal 142 for computing the heat transferred based on the flow rate; alternatively a flow monitor could also be employed on the supply 132 or return 134 lines. The controller 112 also receives a temperature signal 146 from the conditioned space 110, from a sensor 156 or thermostat, and optionally an ambient outside temperature. The heat source 120 is typically based on a combustible fuel source 122, such as oil or gas, and generally has a generation range such as a firing rate of a hydronic boiler for moderating a temperature of the supply line 132. A firing signal 148 controls the firing rate based on the consumption of the fuel source 122, typically expressed as BTUs. The controller 112 employs control logic 113 for computing, based on the flow rate and the differential signal 150, a heat load of the conditioned space 110, and adjusts the flow rate and other parameters, such as the firing rate, to avoid delivering a wasteful excess of heat that can overshoot a thermostatic setpoint, for example. In contrast to conventional circulation pumps, the flow rate of the circulator pump 152 (or a flow control valve) varies based on an actual heating load computed from the temperature differential 150, to deliver an efficient quantity of hot water for heating the conditioned space. Conventional circulators operate at a constant speed, delivering a maximum quantity based only on a temperature shortfall from a thermostat, and not based on actual heat load based on the return line 134 and the difference from the supply line 132.

Configurations of the disclosed approach allow for user or installer input of theoretical heat load calculations, as are known in the art. The controller 112 also receives zone radiation information to understand a zone's output at design water temperatures. To initiate the control sequence, the controller 112 receives zone demand signal(s) or other information indicating that heat is needed. The control system will then set the primary and secondary pump(s) to a minimum design flow rate. After a given time, the demand heat load will be calculated from system data (pump speeds, supply temperature, return temperature) and compared to a theoretical heat load. The controller will then modulate primary and secondary pump(s) speeds and boiler firing rate to meet the required heat load using minimum required flow rates and minimum required supply water temperatures. Although it is not required for operation, additional temperature data from zone sensors or smart thermostats will allow for fine-tuning of controls. Once the temperature set point is reached, the controller 112 may no longer receive zone demand signal(s) or other information. The controller will then return the pumps and firing rate to non-demand settings.

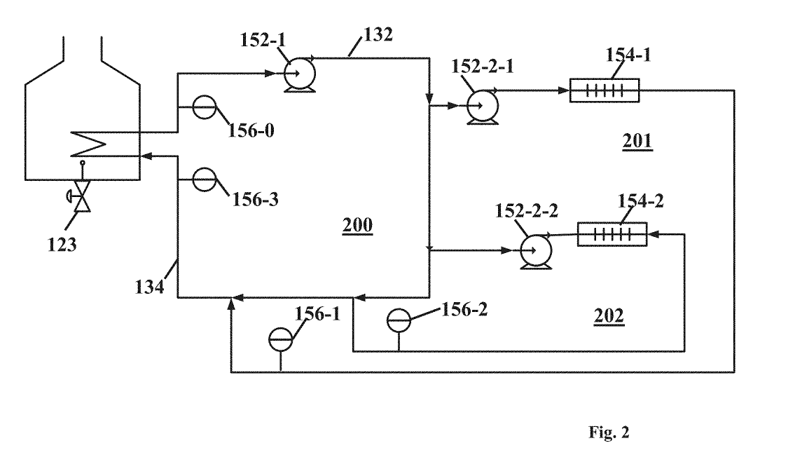

FIG. 2 is a block diagram of a hydronic system in the conditioned space of FIG. 1. Referring to FIGS. 1 and 2, many conditioned spaces 110 are not unilaterally controlled but rather have independent zones, each with separately controllable heat transfer, typically a conventional thermostat and specific radiators. A network of circulators and zone valves controls whether hot water is sent to a circulation loop for each zone. However, the conventional circulators operate in an on/off state, either delivering full flow capacity or none. Similarly, zone valves are either open or closed, meaning that a zone will receive unimpeded hot water flow or none at all. In FIG. 2, a primary loop 200 is governed by a primary pump 152-1, and feeds two secondary loops 201 and 202. Each secondary loop also has a dedicated pump 152-2.1 and 152-2.2, respectively. Respective radiators 154-1 and 154-2 define the convection appliances for heat transfer to the conditioned spaces.

In response to a heat demand, the controller 112 initiates heating the heating fluid 130 in a heating source 120 such as a boiler from which the heating circuit 132 emanates and returns to. The pump speed and resulting flow rate is used to determine a volume of the heating fluid 130 transferred from the heating source 120 to the heating circuit, and the controller 112 measures the heat transfer based on the determined volume and the temperature differential 150 between the supply 132 and the return 134. In the example configuration, measuring the heat transfer includes identifying a flow rate of a pump 152 for circulating the heating fluid 130 through the heating circuit 200, 201 and 202, and determining the heat transfer of the determined volume from a temperature drop indicated by the temperature differential 150 for the determined BTU volume. Control includes regulating the heat (flow rate) delivered by controlling a pump speed of the pump delivering the heating fluid at the determined volume.

A temperature sensor 156-0 on the supply line 132 measures the temperature upon input to the conditioned space 110, and return sensors 156-1 and 156-2 measure the respective return temperatures to ascertain a heat load of the respective conditioned spaces. Another temperature sensor 156-3 may measure the return temperature of the combined return line 134

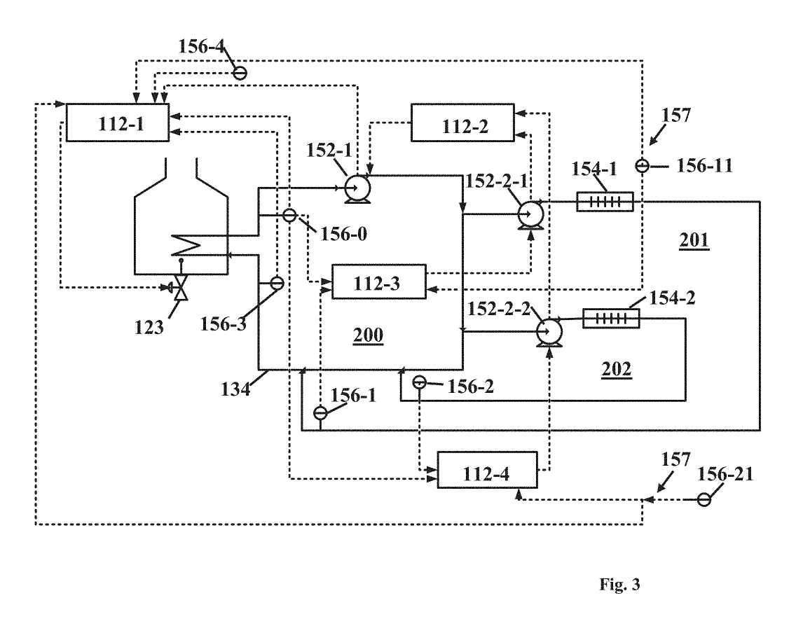

FIG. 3 is a schematic diagram of control in the hydronic system of FIG. 2. In more concise terms, the controller 112 is a programmable system having control logic 113 used to receive on/off signals, system information (OAT, zone temperature, pump flow, supply/return water temperature, boiler firing set point etc., and control output (pump speed, boiler firing rate input signal, etc.) to meet setpoint. This controller 112 can be incorporated in the boiler, pumps, thermostat, or even be a standalone unit. Referring to FIGS. 1-3, in the examples herein, the control logic 113 includes a number of control loops for evaluating temperature and other sensed parameters and controlling operational parameters such as circulator speed and boiler firing rate, to name several. The control loops, such as a fuel control loop 112-1, a primary pump output 112-2 control loop, a zone 1 secondary pump output loop 112-3 and a zone 2 secondary pump output loop 112-4, control different operational parameters based on sensed parameters. The sensed parameters define input information, which includes any data utilized by the controller 112. This may be as simple as a traditional zone thermostat on/off signal, but could also include temperature data from zone sensors or smart thermostats. It is not limited to wired connections and could be conveyed by WiFi or other wired or wireless communications protocols. Each loop transfers heat to respective conditioned spaces 110 via radiators 154-1, 154-2. The measured temperature differential and flow rate determine the number of BTUs transferred to the conditioned space 110.

In an example system, secondary pump output loops 112-3 and 112-4 regulate speed (output) to deliver a specific BTU delivery based on the computed heat load, and regulating the primary pump output (loop 112-2) based on a total demand of the secondary loops. A fuel control loop 112-1 regulates a fuel valve 123 to control the boiler firing rate in conjunction with the BTU demand, and may include other sensed parameters, such as from an outside air temperature sensor 156-4 and a primary loop return sensor 156-3.

The resulting control will enable load calculations to index firing rate for burner capacity in addition to allowing for controlling the GPM to the primary pump of the boiler system to only operate at the required gpm to satisfy BTU load requirements. For example, such control allows the system to operate as one complete system whereas each system adjustment is calculated and controlled as to not affect total system performance on other system attributes. If two heating system zones are calling for heat with 4 gpm per zone, if one zone stops calling for heat, the system realizes a need to reduce primary pump capacity by a minimum of 4 gpm. If this change does not occur, the return water temperature will rise due to recirculation of the supply water and the higher return water will result in the boiler operating less efficiently as it makes it harder to maintain water temperatures that allow a boiler to operate at higher return water temperatures resulting in less efficient operation.

FIG. 3 depicts the use of a primary circuit 200 supplying two secondary circuits 201, 202, therefore the total volume of the secondary circuits 201, 202 draws from the primary circuit 200. Various combinations of primary and secondary loops, as well as heat loads, such as for conditioned spaces and hot water, may be employed. In the example of FIG. 3, the hydronic heating fluid 130 is delivered to a primary circuit 200 and one or more secondary circuits 201, 202, in which each secondary circuit has a supply sensor on primary loop and a return sensor on each circuit for measuring the temperature differential. The supply temperature of each of the secondary circuits is provided from the heating fluid 130 delivered to the primary circuit 200, via sensor 156-0, and further includes controlling a pump speed of the pump 152-1 delivering the heating fluid to each respective secondary circuit 201, 202. The controller 112 computes the heating demand for each of a plurality of conditioned spaces 110, in which each of the conditioned spaces corresponds to one of the secondary circuits 201, 202. The controller regulates the heat delivered to each of the secondary circuits 201, 202 by controlling the pump speed of the respective pump based on a demand computed from a flow rate and temperature differential of each of the secondary circuits. In the example configuration, the controller 112 first computes initial setpoints using OAT and design information only. Then the controller computes the heat transfer by receiving a signal from a temperature sensor 156-1, 156-2 at the return of the heating circuit, receives a signal from a temperature sensor 156-0 at the supply of the heating circuit, and computes the temperature differential based on a difference between the temperature sensors 156. The controller 112 concludes the measured heat transfer based on the volume of heating fluid 130 and the temperature drop of the volume of heating fluid as heat transferred to satisfy the heating demand of the conditioned space. Since the secondary loops 201, 202 both draw from the volume in the primary circuit 200, flow rates are interrelated. After some time of heat transfer, as the heat in the conditioned space increases and approaches a desired setpoint, the controller 112 may detect an indication of a change in heating demand in one secondary circuit of the plurality of secondary circuits, and modifies the flow rate of the primary circuit according to the detected change. Individual pumps 152-2-1 and 152-2-2 for the secondary loops 201, 202 control respective flow to each of the secondary loops. A primary loop temperature sensor 156-3 measures the primary loop 200 return aggregated from each of the secondary loops 201, 202.

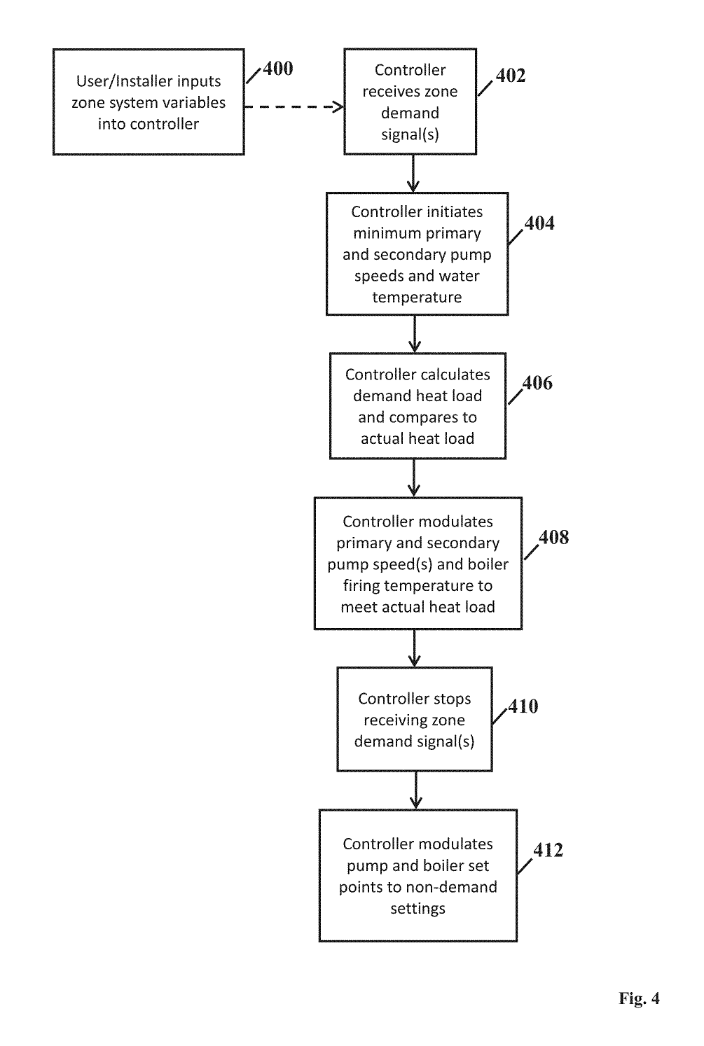

Advantages of particular configuration of the disclosed approach are illustrated by operation according to FIG. 4. The proposed approach offers advantages and improvements over conventional approaches by receiving or “understanding” system information to allow the boiler to control equipment to more efficiently meet actual heat load demand. Configurations herein include primary and secondary pump speeds are based actual system demands, not the maximum output rate as in conventional approaches. This allows oversized systems to be operated more efficiently since they can be operated at actual requirements, and saves energy by making sure that return water temperature are optimized to provide lower return water temperatures and can allow condensing flue gas temperatures to be reached within the boiler. The approach also saves electrical costs by running pumps at lower speeds and avoiding on/off cycling. The boiler firing rate is based on actual system demands, not the maximum. The controller 112 automatically calculates required water temperature based on zone settings and sets the firing rate accordingly, which saves energy and fuel costs because a lower firing rate can be used and avoids excessive cycling and pre/post purges of boiler.

FIG. 4 is a flowchart of hydronic control of the system in FIG. 3 according to configurations herein. Referring to FIGS. 3 and 4, in the conditioned space 110 to be serviced according to configurations herein, a user/installer inputs zone system heat load and radiation information into the controller 112, as depicted at step 400. Load and radiation information generally specify the capacity of system components, such as a BTU transfer rate of radiators 154 based on BTU per foot, and areas of exterior walls and insulation therein, to approximate starting operational parameters. Heat transfer is further dependent on the temperature of the heating fluid flowing through it, discussed further below.

In the course of operation, the controller 112 receives zone demand signals 157 indicating a call for heat, as disclosed at step 402. The demand signal 157 is typically from zone thermostats or sensors, sensors 156 or other input information. In response, the controller 112 initiates minimum primary 152-1 and secondary pump 152-2 speeds/flows and water temperature (in response to boiler firing rate), as depicted at step 404. Using the sensed parameters, the controller 112 calculates actual head load and compares it to theoretical heat load, as disclosed at step 406. In contrast to conventional thermostatic on/off signals, an actual demand heat load is calculated from secondary pump speed/flow, supply temperature, return temperature, and other inputs to compute the actual BTUs transferred to the conditioned space. A theoretical heat load is calculated using OAT or actual zone temperature sensors with boiler reset curves.

Based on the control logic 113 and associated control loops 112-1 . . . 112-4, the controller 112 modulates primary and secondary pump speed/flow and boiler firing temperature to meet actual heat load, as depicted at step 408, in controls to conventional switching of single-speed pumps and static boiler firing rates. Following the controlled response, a check is performed at step 410 to determine when the controller 112 stops receiving zone demand signals 157 based on the sensors 156-11, 156-12. In other words, the controller 112 provides a metered response to the demand signal 157 based on the magnitude of the computed demand. Conventional approaches respond with a full pump flow and firing rate, rather than a modulated response based on the actual demand. Upon demand satisfaction, the controller 112 modulates pump(s) and boiler set points to non-demand settings, as depicted at step 412, rather than suddenly curtailing pump flow and boiler firing.

A particular generalized operational scenario may be as follows.: For zone circulators BTU calculations will be based on actual GPM input, known gpm or calculated flow based on parameter inputs by the installer during setup of each zone. The control will enable a primary circulator output and/or a zone circulator output when a zone calls for heat by an external thermostat control allowing the pump to distribute heating water flow from a primary zone to a secondary zone (when applicable—not required). The system zone circulator will be energized and operate independently, the control algorithm feedback is dependent on the type of pump selection to determine how the primary boiler system pump will operate. The primary boiler pump will be sent a control signal to enable minimum output gpm required by boiler or X %>than total secondary zone GPM requirements or actual system demand for boiler system flow requirements. Upon a second zone call for heat by a secondary zone, the controller will sum up the BTU's of (secondary) zone 1 and zone 2 to calculate required flow for total system demand or use actual GPM inputs where applicable after both zones have satisfied a zone delay period for the calculations to become actively optimized. Each zone must satisfy the adjustable minimum run time requirements to be included in the BTU calculation and have an impact on outputs which are controlled by the process. Additional zones would be calculated in a similar manner with each new zone providing additional BTU loads or gpm requirements to be calculated for primary pump output control and BTU demand for boiler input capacity control. The BTU calculation output is only enabled after the zone has been calling for the adjustable minimum runtime which is the trigger for the boiler modulation output enable calculation. The BTU calculation may control the output to the secondary pump, primary boiler circulator pump, burner capacity input and/or boiler reset temperature input

In another particular scenario, on a call for heat—control signal sent to secondary zone relay which results in a output control signal being sent to secondary pump and primary pump when applicable.
Control timer starts, BTU calculator disabled, boiler water secondary loop pump signal enabled, primary pump enable when applicable in enabled with control to minimum flow required, boiler reset input signal set to minimum setting when used'
After adjustable zone delay timing flag expires, control timer triggers BTU calculator input to control primary boiler pump to desired flow setting, control of input to boiler modulation input to burner based on calculated system demand input.
Call for heat—control signal from zone 2 output enabled, primary circulator trigger is already enabled by zone 1 call for demand.
A call for heat from a second zone (secondary), zone 2 BTU calculator allows primary pump input calculation. Burner modulation output disabled for the second zone until the selected adjustable period expires, the control calculated demand based on zone 1 calculator and/or minimum input of Zone 2 primary pump input as defined by delay period. Zone circulator controls zone as required by setup of pump operation.
After zone 2 time delay expiration, BTU calculator is enabled for zone 2 modulating boiler input which is additive to zone 1 calculated input. Processor will provide calculated input for primary boiler pump output and/or modulating burner input reset.
Boiler outdoor reset input is controlled by supply water temperature and outdoor air temperature. If supply water temperature exceeds supply water reset curve, burner modulating output to boiler will be altered to provide a reduced signal. Output to modulating burner reset is a function of zone demand for zones calling for heat, supply water, return water and outdoor air temperature. Primary boiler pump output is controlled based on BTU requirements of all zones.

The disclosed approach differs from conventional HVAC system design because theoretical approximations, based on building materials, area/volume and exterior exposure, are supplemented, or fine-tuned, with a calculated or actual demand based on the thermal input, or energy, actually consumed by the conditioned space. A specific example employing the steps of FIG. 4 illustrates how the theoretical and computed demands are employed. It should be emphasized that the example below depicts a residential hydronic system using linear baseboard for heat exchange, and that the principles and methods disclosed herein are applicable to other fluidic heat transfer mediums, such as air, and other heat exchange apparatus, such as radiators, radiant flooring, and vent/duct arrangements, to name several. Cooling (air conditioning) applications are equally applicable.

In this example, the controller 112 computes and/or receives a theoretical demand based on physical properties of the conditioned space 110, and computes the heating demand based on the theoretical demand and the measured heat transfer from the conditioned space. Physical properties include the construction materials such as walls, insulation and roofs, corresponding heat loss based on ambient temperatures, and the types and extent (size) of heat exchangers—baseboards, radiators and/or vents.

This example shows how the disclosed approach operate step-by-step based on FIG. 4 for the following hypothetical scenario of boiler setup and outdoor air temperature in a simple scenario of a single zone heating demand by describing how demand from additional heat zones and a hot water zone would be handled (note that domestic hot water demands are sometimes satisfied by a separate zone of the environmental HVAC system). The information selected to depict an example home is provided to illustrate how the proposed approach works, but could vary in terms of final programming and implementation. Example parameters and characteristics of this example include the following design parameters:
Residential copper fin and tube radiation and a boiler with maximum net output of 70,000 BTU/hr
Outdoor air temperature of 30 F
Zone 2 Maximum design heat load of 28,000 BTU/hr
Boiler reset input: 2-10 VDC

As depicted in step 400, the installing technician will input data into the controller 112 to determine zone heat loads and radiation information. Room heat load (maximum design) is found using a Manual J calculator or other commercially available heat zone calculator, as is known in the art, by inputting specific variables such as room volume, window area, exposure, external wall area, insulation, etc.

The Design Zone heat load (maximum design)=Sum of Room heat loads in zone at 10 F (or minimum design temperature based on load location for a design day)

The Zone length of baseboards=feet of finned radiation in a given zone

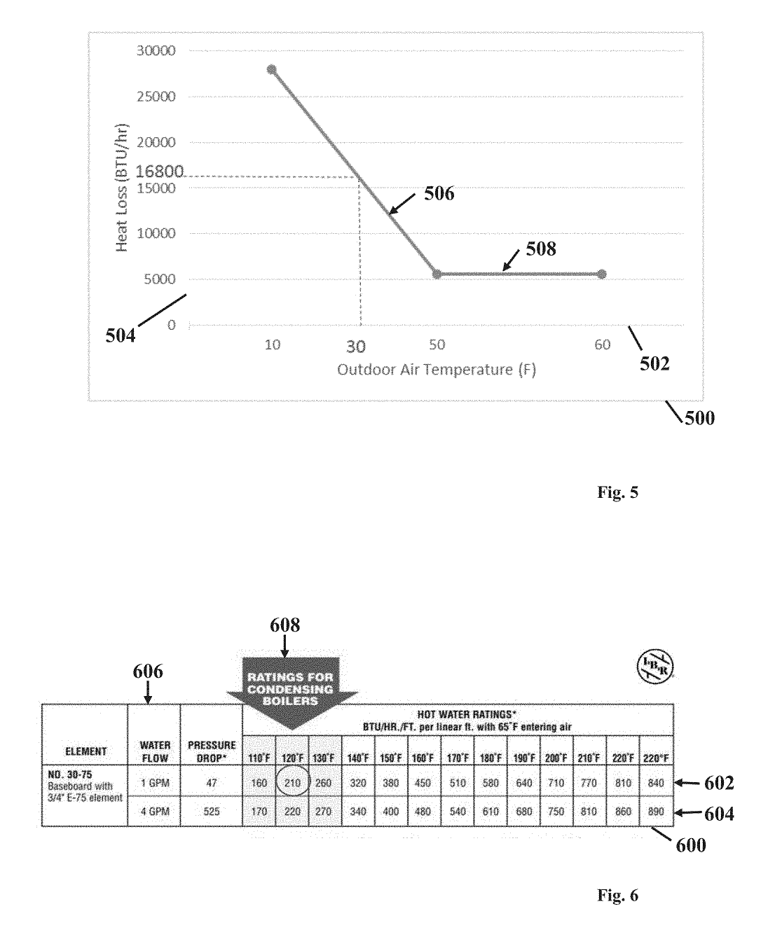

The information in Table 1 above represents a house based on its specific setup. This data will be used to construct a heat loss graph as shown in FIG. 5 and perform calculations using boiler specifications of FIG. 6.

At step 402, the controller 112 receives a demand signal from the Zone 2 thermostat, indicating that heat is required, typically a standard 24 v thermostat circuit signal, however any suitable demand signal may be employed.

At step 404, the controller determines an initial pump speed set point to meet the theoretical demand determined above, based on the design parameters. Regulating the heat delivered therefore includes modulating a pump speed according to the boiler specification 600, in which the boiler specification 600 is indicative of heat transfer per a volume of the heating fluid 130. Conventional approaches assume that the theoretical demand is accurate, and continue to supply heat according to this theoretical demand without correlating with actual computed demand, as disclosed herein.

FIG. 5 is a heat loss graph used for computing the theoretical demand of FIG. 4. Referring to FIG. 5, a table 500 shows heat loss (axis 504) based on ambient outside air temperature on axis 502. The sloped section 506 indicates a theoretical value for heat loss 140 that varies inversely with the temperature 502, leveling off at 508 when the theoretical heat loss becomes negligible.

FIG. 6 is a boiler specification used for implementing the computed demand of FIG. 4. Referring to FIGS. 1 and 4-6, boiler specifications 600 vary by manufacturer, and indicate for a particular pump speed 606, at a particular temperature 608, the transferred heat (BTUs) for each of pump speeds 1 GPM (602) and 4 GPM (604).

To compute the actual demand, the controller 112 receives data from the Outdoor Air Temperature (OAT) sensor, showing a value of 30 F. Using the heat loss graph 500, the controller 112 uses linear interpolation of the current OAT and design heat load to determine that a Calculated Zone 2 heat load is 16,800 BTU/hr. The controller 112 then uses the Calculated Zone 2 Heat load and Zone 2 length of baseboards (from Table 1) to determine an initial secondary pump speed set point and water temperature set point using fin and tube manufacturer information in the boiler specification 600. This computation yields that the heat load/length of baseboards=16,800 BTU/hr/80 ft=210 BTU/hr.

Based on the boiler specification information in FIG. 6, the secondary pump speed of 1 GPM and 120 F supply water temperature is needed to obtain the required heat load. As such, the controller 112 will utilize the initial set points shown below.

Secondary pump speed=1 GPM

Primary pump set point=1.2*secondary pump speed=1.2 GPM (or boiler manufacturer minimum flow rate and adjustable per zone requirements)

Supply water temperature=120 F

The controller 112 then determines an initial boiler firing rate set point to the meet theoretical demand. Based on analysis of the previous step, it was identified that a supply water temperature of 120 F is needed to meet the heat load. The controller 112 programming will increase the boiler firing rate (such as proportionally at 3 degrees/minute (adjustable) until the initial supply water set point is met, as follows:

Boiler firing rate set point=16,800/70,000 BTU=24%

Boiler firing rate control input: 3.92 VDC (2 VDC+(8*0.24)=3.92

At step 406, the: controller 112 compares the calculated demand to the theoretical demand to revise and/or confirm the initial set points The initial set points (pump speeds, supply water temperature, boiler firing rate) were based on theoretical calculations of the heat load. In order to fine-tune the set point values for what the space actually needs, the actual heat load is calculated as shown below.

Actual heat load=Secondary pump flow rate*(Supply Temperature-Return Temperature)*Specific Heat

The controller 112 then determines whether the computed heating demand is greater than or less than the theoretical demand; adjusts pump speed and firing rate accordingly. The controller 112 increases, if the computed heating demand is greater and the pump speed modulation insufficient to meet the computed heating demand, a supply temperature of the heating fluid, and decreases, if the computed heating demand is less and a minimum pump speed exceeds the computed heating demand, a supply temperature of the heating fluid. Therefore, the response of the controller 112 depends on whether the actual heat load is more or less than the theoretical, so will be explained based on the two potential cases. If the actual heat load is equal to the theoretical heat load, the set points will not change.

Case 1: Actual zone heat demand is lower than required 16,800 BTU/hr
Actual heat demand (Case 1)=1 GPM*25.6*500=12,800 BTU/hr

When the controller 112 identifies that the actual heat demand is less than the theoretical, it will modulate pump speed and/or supply water temperature higher based on Table 2 above. In this case, the secondary pump speed can be ramped up to 4 GPM to meet the demand. If this did not meet calculated demand, the supply water temperature would also be increased. The following results are observed:

Secondary pump speed=4 GPM

Primary pump set point=1.2*secondary pump speed=4.8 GPM (or boiler manufacturer minimum flow rate)

Supply water temperature Set Point=120 F

Boiler firing rate=17,600/70,000=25%

Boiler output: on

Boiler firing rate control input: 2+(8*0.25)=4.00 VDC

Case 2: Actual zone heat load is higher than required 16,800 BTU/hr
Actual heat load (Case 2)=1 GPM*35.2*500=17,600 BTU/hr

If the controller 112 identifies that the actual heat demand is greater than the theoretical, it will modulate pump speed and/or supply water temperature lower based on the boiler specifications 600. In this case, the secondary pump is already at the minimum speed so it cannot be reduced further. However, reducing the supply water temperature to 110 F will meet the calculated demand, yielding the following results:

Secondary pump speed =1 GPM

Primary pump set point =1.2*secondary pump speed=1.2 GPM (or boiler manufacturer minimum)

Supply water temperature Set Point=110 F

Actual supply water temperature—108 F

Boiler firing rate=12,800/70,000=18%

Boiler output: On

Boiler firing rate control input: 2+(8*0.18)=3.44 VDC

Step 408 includes verification that demand will be met. Finally, the controller 112 checks if the demand is forecasted to be met within a forecast time (ex: 15 min—adjustable by user). If it is not, the system will go through a programmed sequence. The response depends on whether there is numerical data from a space temperature sensor. The final goal will be for the system to reach set point in a specified time (ex: 60 minutes-adjustable by user).

### Case 1: No Space Temperature Sensor Data

Many traditional thermostats utilize on/off signal only and do not have the capability to provide temperature data to the boiler. Without this, after the specified delay time (15 minutes in this example), the controller 112 would just ramp up supply water 130 temperature at a specified rate (ex: 3 degrees/minute-adjustable by user) until demand is satisfied.

### Case 2: Space Temperature Sensor Data

If the thermostat has the capability to provide temperature data, this information may be invoked. After a specified delay time (15 minutes in this example) the controller 112 compares the temperature set point to the temperature gained. It will then be able to calculate the required BTUs/hr to reach the temperature set point +/−0.5 degrees within the goal time (60 minutes in this example).

For example, 11,000 BTU/hr is supplied to space and temperature increases 0.5 degrees over fifteen minutes. In order to reach temperature set point and increase 4 more degrees within 60 minutes, 22,000 BTU/hr is needed. The controller would then calculate a new secondary pump speed set point and water temperature set point using the same analysis performed above.

At steps 410 and 412, zone demand is met, and the controller 112 receives a signal from the space thermostat and reverts pump speeds and boiler firing rate to non-demand set points such as those shown below.

Secondary pump speed=0 GPM

Primary pump set point=Boiler manufacturer minimum GPM for a minimum off delay (adjustable)

Supply water temperature Set Point=120 F

Boiler firing rate=0%

Boiler output disabled: off

Additional zone demands and control define alternate configurations, typically similar in design and including additions for domestic hot water control. Each of these scenarios is described further below.

Additional heating zone control may be implemented as follows. The example above showed Zone 2 heating demand only. If Zone 3 demanded heat at the same time, it would follow similar analysis, using the following parameters:

At 30 F, the Calculated Zone 3 heat load is 11,440 BTU/hr.

Heat load/length of baseboard =11,440 BTU/hr/52 ft =220 BTU/hr for Zone 3

Looking up 220 BTU/hr in the boiler specification 600 information, the following set points are obtained:

Zone 3 Secondary pump speed =4 GPM

Supply water temperature Set Point=120 F

Adding these set points to the Zone 2 demands, we have the following results for the entire system:

Zone 2 Secondary pump speed=1 GPM

Zone 3 Secondary pump speed=4 GPM

Primary pump set point =1.2*(Sum of secondary pump speeds) =1.2*(1 GPM+4 GPM) =6 GPM (or boiler manufacturer minimum and adjustable per zone requirements)

Supply water temperature Set Point=120 F

Boiler firing rate=Sum of zones BTU/Maximum=(11,440+12800)/70,000=35%

Boiler output: on

Boiler firing rate control input: 2+(8*0.35)=4.8 VDC

When one (or both) of the zones no longer demands heat, the primary and secondary pump speeds will be reduced accordingly to satisfy zone demand.

Another configuration addresses hot water zone control Domestic hot water control is an optional setup option. When setup by the user, the hot water control is similar in control as other zones, however is controlled by maintaining user input for design supply hot water temperature shown below.

Zone 1 BTU Domestic Output Required: 45,000 BTU/hr

Hot Water Supply water temperature Set Point=190 F

Thermostat of domestic hot water: enabled

Boiler output—on

The supply water temperature is then brought to set point by the controller using a PID loop and adjusting the boiler firing rate accordingly. Note that when Zone 1 is calling for demand, BTU calculator for firing rate calculation is disabled, but will continue to control pump speeds for all other zones. If zone 1 calls is enabled for >15 minutes (adjustable), all other heating pump zones are disabled until zone 1 is satisfied. After zone 1 is satisfied, zones will resume normal operation. Parameters are as follows:

Zone 1 Secondary pump speed (fixed based on user input)=6 GPM

Boiler firing rate (determined by PID loop)=45,000/70,000=64%

Boiler output: on

Primary pump set point =1.2*(Sum of secondary pump speeds) =1.2*6 GPM (or boiler manufacturer minimum and adjustable per zone requirements)=7.2 GPM

Boiler firing rate control input: 2+(8*0.64)=7.12 VDC

Adding these set points to the Zone 2 demands, we have the following summary for the entire system. Note that the supply water temperature defaults to the higher value for hot water.

Zone 1 Secondary pump speed=6 GPM

Zone 2 Secondary pump speed =1 GPM

Primary pump set point=1.2*(Sum of secondary pump speeds)=1.2*(1 GPM+6 GPM)=8.4 GPM (or boiler manufacturer minimum and adjustable per zone requirements)

Supply water temperature Set Point=190 F

Zone 2 will then utilize the BTU load calculator to determine a new lower pump speed since the supply water temperature is higher. The firing rate with Zones 1 & 2 calling is the supply water temperature set point of 190 F. With zone 1 satisfied, control will revert back to zone calculation procedures aforementioned

Alternate configurations of the invention include a multiprogramming or multiprocessing computerized device such as a multiprocessor, controller or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded as instructions thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for controlling a heating apparatus, comprising:
delivering a heating fluid to a conditioned space via a heating circuit for satisfying a heating demand, the heating circuit having a supply and return from the conditioned space;
measuring a heat transfer resulting from a flow of the heating fluid from the source to the return of the conditioned space;
computing a heating demand of the conditioned space based on the measured heat transfer; and
regulating the heat delivered to the conditioned space in response to the computed heating demand.

2. The method of claim 1 further comprising measuring the heat transfer based on a temperature differential between the supply and the return, the temperature differential indicative of the heat transferred from the heating fluid to the conditioned space.

3. The method of claim 2 further comprising computing a theoretical demand based on physical properties of the conditioned space, and computing the heating demand based on the theoretical demand and the measured heat transfer.

4. The method of claim 3 wherein regulating the heat delivered includes:
modulating a pump speed according to a boiler specification, the boiler specification indicative of heat transfer per a volume of the heating fluid.

5. The method of claim 4 further comprising determining whether the computed heating demand is greater than or less than the theoretical demand; and
increasing, if the computed heating demand is greater and the pump speed modulation insufficient to meet the computed heating demand, a supply temperature of the heating fluid; and
decreasing, if the computed heating demand is less and a minimum pump speed exceeds the computed heating demand, a supply temperature of the heating fluid.

6. The method of claim 2 further comprising:
heating the heating fluid in a heating source from which the heating circuit emanates and returns to;
determining a volume of the heating fluid transferred from the heating source to the heating circuit;
measuring the heat transfer based on the determined volume and the temperature differential between the supply and the return, the conditioned space including at least one of an interior region and a potable hot water supply.

7. The method of claim 6 wherein measuring the heat transfer includes:
identifying a flow rate of a pump for circulating the heating fluid through the heating circuit;
determining the heat transfer from the determined volume from a temperature drop indicated by the temperature differential for the determined volume.

8. The method of claim 6 further comprising regulating the heat delivered by controlling a pump speed of a pump delivering the heating fluid at the determined volume.

9. The method of claim 6 further comprising regulating the heat delivered by controlling a fuel control valve and resulting combustion rate of the heating source.

10. The method of claim 8 wherein the hydronic heating fluid is delivered to a primary circuit and one or more secondary circuits, each secondary circuit having a supply and a return, the supply of each of the secondary circuits provided from the heating fluid delivered to the primary circuit, further comprising controlling a pump speed of a pump delivering the heating fluid to each respective secondary circuit.

11. The method of claim 10 further comprising computing the heating demand for each of a plurality of conditioned spaces, each of the conditioned spaces corresponding to one of the secondary circuits, further comprising regulating the heat delivered to each of the secondary circuits by controlling the pump speed of the respective pump based on a demand computed from a flow rate and temperature differential of each of the secondary circuits.

12. The method of claim 8 further comprising computing the heat transfer by:
receiving a signal from a temperature sensor at the return of the heating circuit;
receiving a signal from a temperature sensor at the supply of the heating circuit,
computing the temperature differential based on a difference between the temperature sensors, and
concluding the measured heat transfer based on the volume of heating fluid and the temperature drop of the volume of heating fluid as heat transferred to satisfy the heating demand of the conditioned space.

13. The method of claim 10 further comprising:
detecting an indication of a change in heating demand in one secondary circuit of the plurality of secondary circuits; and
modifying the flow rate of the primary circuit according to the detected change.

14. The method of claim 1 wherein measured heat transfer includes at least one of pump pressure, pump volume, pump speed, radiator BTU per foot, radiator length.

15. The method of claim 1 wherein the computed heat demand includes at least one of supply temperature, return temperature, boiler temperature, firing rate, fuel valve setting.

16. A controller device for a heating apparatus, comprising:
a heat source for delivering a hydronic heating fluid to a conditioned space via a heating circuit for satisfying a heating demand, the heating circuit having a supply and return from the conditioned space;
an interface to at least one sensor for measuring a heat transfer resulting from a flow of the heating fluid from the source to the return of the conditioned space;
control logic for computing a heating demand of the conditioned space based on the measured heat transfer; and
an interface to a pump motor regulating the heat delivered to the conditioned space in response to the computed heating demand.

17. The device of claim 16 wherein the control logic is configured to measure the heat transfer based on a temperature differential between the supply and the return, the temperature differential indicative of the heat transferred from the heating fluid to the conditioned space.

18. The device of claim 17 wherein the control logic is configured to:
direct a firing rate for heating the heating fluid in a heating source from which the heating circuit emanates and returns to;
determine a volume of the heating fluid transferred from the heating source to the heating circuit; and
measure the heat transfer based on the determined volume and the temperature differential between the supply and the return.

19. The device of claim 18 wherein measuring the heat transfer includes:
identifying a flow rate of a pump for circulating the heating fluid through the heating circuit; and
determining the heat transfer from the determined volume from a temperature drop indicated by the temperature differential for the determined volume.

20. The device of claim 18 wherein the control logic is operable to regulate the heat delivered by controlling a pump speed of a pump delivering the heating fluid at the determined volume, wherein the hydronic heating fluid is delivered to a primary circuit and one or more secondary circuits, each secondary circuit having a supply and a return, the supply of each of the secondary circuits provided from the heating fluid delivered to the primary circuit, further comprising controlling a pump speed of a pump delivering the heating fluid to each respective secondary circuit.

21. The device of claim 20 wherein the controller is configured to compute the heat transfer by:
receiving a signal from a temperature sensor at the return of the heating circuit;
receiving a signal from a temperature sensor at the supply of the heating circuit,
computing the temperature differential based on a difference between the temperature sensors, and
concluding the measured heat transfer based on the volume of heating fluid and the temperature drop of the volume of heating fluid as heat transferred to satisfy the heating demand of the conditioned space.

22. The device of claim 20 further comprising:
detecting an indication of a change in heating demand in one secondary circuit of the plurality of secondary circuits; and
modifying the flow rate of the primary circuit according to the detected change.

23. A computer program product on a non-transitory computer readable storage medium having instructions that, when executed by a processor, perform a method for controlling a heating apparatus, the method comprising:
delivering a hydronic heating fluid for satisfying a heating demand, the heating demand including at least one of an interior region and a potable hot water supply;
measuring a heat transfer by the heating fluid;
computing a heating demand based on the measured heat transfer; and
regulating the heat delivered to the conditioned space in response to the computed heating demand, further comprising computing the heating demand for each of a plurality of heating circuits, each of the heating demands corresponding to a secondary circuit, further comprising regulating the heat delivered to each of the secondary circuits by controlling the pump speed of the respective pump based on a demand computed from a flow rate and temperature differential of each of the secondary circuits and a primary circuit delivering the heating fluid to each of the secondary circuits.
